(19) United States
(12) Patent Application Publication
(10) Pub. No.: US 2025/0073550 A1
(43) Pub. Date: Mar. 6, 2025

(54) FACE SHEET FOR A PICKLEBALL PADDLE

(71) Applicant: Michael N. Werneke, Apple Valley, MN (US)

(72) Inventor: Michael N. Werneke, Apple Valley, MN (US)

(21) Appl. No.: 18/699,644

(22) PCT Filed: Feb. 29, 2024
(86) PCT No.: PCT/US2024/017829

§ 371 Date: Apr. 9, 2024

Related U.S. Application Data
(60) Provisional application No. 63/515,948, filed on Jul. 27, 2023.

(51) Int. Cl. A63B 59/42; A63B 60/14; A63B 102/08

(52) U.S. Cl. CPC A63B 59/42; A63B 60/14; A63B 2102/08

(57) ABSTRACT

The present disclosure provides for a face sheet for resurfacing a pickleball paddle. The face sheet includes a backing having a first major surface and a second major surface opposite the first major surface, where the first major surface and the second major surface include a patterned texture on at least a portion of the first major surface to provide grip against a surface of a pickleball being struck by the pickleball paddle having the face sheet. The face sheet can further include an adhesive material on at least a portion of the second major surface of the backing, where the adhesive material helps to secure the face sheet to the pickleball paddle.

### TECHNICAL FIELD

The present disclosure relates to a pickleball paddle and in particular to a face sheet for resurfacing a pickleball paddle.

### BACKGROUND

Pickleball is a cross between tennis, badminton, and ping pong. It is one of, if not the, fastest growing sports in America. Pickleball is played on a pickleball court using a pickleball paddle and a pickleball, which is a plastic perforated ball. The pickleball paddle includes a face structure, which includes a playing surface that comes into direct contact with the pickleball. The pickleball paddle also includes a core, which is the inner part of the paddle situated between two of the face structures. The core can be made of a lightweight material such as wood, graphite, aramid based fibers (e.g., Nomex®), composite blends or aluminum, while the face structure can be made of polymeric materials or composite materials formed with graphite, carbon fiber and/or fiberglass. The design specifications of the paddle core and playing surface of the face structure are important factors that can affect performance of the pickleball paddle.

Another aspect of pickleball is that the pickleball paddles can be expensive, with some costing well into the hundreds of dollars. Maintaining and caring for a pickleball paddle is therefore important. The nature of pickleball, however, is hard on the paddle and in particular the playing surface of the face structure. The stress put on a pickleball paddle during play can cause the playing surface of the face structure, as well as the core, to break down over time. Currently, there are no means or processes by which to repair pickleball paddles, which means the entire pickleball paddle is replaced when such a breakdown occurs.

As can be seen, there is a need for means and processes to repair pickleball paddles.

### SUMMARY

The present disclosure provides for means and processes to repair or refurbish pickleball paddles. In particular, the present disclosure provides for means and processes to repair pickleball paddles that is both easy enough and inexpensive enough to be achievable by most anyone.

For the various embodiments, the present disclosure provides for a face sheet for resurfacing a pickleball paddle, as discussed herein. The face sheet includes: a backing having a first major surface and a second major surface opposite the first major surface, where the first major surface and the second major surface include: a first major edge having a first major linear portion extending between a first end and a second end, a first convex corner extending from the first end, a second convex corner extending from the second end, a first concave corner extending from the second convex corner and a first minor edge portion extending from the second convex corner away from both the first end and the second end of the first major linear portion; a second major edge having a second major linear portion extending between a third end and a fourth end, a third convex corner extending from the third end, a fourth convex corner extending from the fourth end, a second concave corner extending from the fourth convex corner and a second minor edge portion extending from the fourth convex corner away from both the third end and the fourth end of the second major linear portion; a third major edge having a third major linear portion extending between the first convex corner of the first major edge and the third convex corner of the second major edge; a first minor edge extending between the first minor edge portion and the second minor edge portion; a first tab extending from the first minor edge portion of the first major edge; and a second tab extending from the second minor edge portion of the second major edge; and a patterned texture on at least a portion of the first major surface to provide grip against a surface of a pickleball being struck by the pickleball paddle having the face sheet of the present disclosure. For the embodiments, the face sheet can further include an adhesive material on at least a portion of the first tab and the second tab. For the embodiments, the first tab and the second tab can be or are covered with the adhesive material. In additional embodiments, the first tab can include a first surface defining hook structures and the second tab includes a second surface defining loop structures that releasably engage with the hook structures of the first surface. For the embodiments, the backing can further include a reinforcement strip that extends from the third major edge and the first minor edge. For the embodiments, the reinforcement strip can extend adjacent to the first major edge, the second major edge and the third major edge to a position between the first tab and the second tab.

The embodiments of the present disclosure also provide for a face sheet for resurfacing a pickleball paddle, where the face sheet includes: a backing having a first major surface and a second major surface opposite the first major surface, where the first major surface and the second major surface include: a first major edge having a first major linear portion extending between a first end and a second end, a first convex corner extending from the first end, a second convex corner extending from the second end, a first concave corner extending from the second convex corner and a first minor edge portion extending from the second convex corner away from both the first end and the second end of the first major linear portion; a second major edge having a second major linear portion extending between a third end and a fourth end, a third convex corner extending from the third end, a fourth convex corner extending from the fourth end, a second concave corner extending from the fourth convex corner and a second minor edge portion extending from the fourth convex corner away from both the third end and the fourth end of the second major linear portion; a third major edge having a third major linear portion extending between the first convex corner of the first major edge and the third convex corner of the second major edge; a first minor edge extending between the first minor edge portion and the second minor edge portion; and a reinforcement strip that extends from the third major edge and the first minor edge; and a patterned texture on at least a portion of the first major surface to provide grip against a surface of a pickleball being struck by the pickleball paddle having the face sheet of the present disclosure. For the embodiments, the reinforcement strip can extend adjacent to the first major edge, the second major edge and the third major edge to a position between the first tab and the second tab. For the embodiments, the backing can further include a first tab extending from the first minor edge portion of the first major edge; and a second tab extending from the second minor edge portion of the second major edge. For the embodiments, the face sheet can further include an adhesive material on at least a portion of the first tab and the second tab. For the embodiments, the first tab and the second tab are covered with the adhesive material. In alternative embodiments, the first tab can include a first surface defining hook structures and the second tab includes a second surface defining loop structures that releasably engage with the hook structures of the first surface.

For any of the embodiments provided herein, the face sheet can further include an adhesive material on at least a portion of the second major surface of the backing, where the adhesive material helps to secure the face sheet to the pickleball paddle. In certain embodiments, the adhesive material is not present between the first minor edge portion and the second minor edge portion of the backing. In other embodiments, the adhesive material is present between the first minor edge portion and the second minor edge portion of the backing. For the embodiments, the adhesive material is selected from the group consisting of contact cement, a thermoplastic based adhesive, a cyanoacrylate based adhesive, a polyurethane based adhesive, a pressure-sensitive adhesive, an acrylic-based adhesive, a rubber-based adhesive, a hot-melt adhesive and combinations thereof. For the embodiments, the backing can be or is formed of graphite, carbon fiber, fiberglass, aramid fiber, a thermoplastic film, wood pulp, a woven fabric, a felted fabric and combinations thereof. For the embodiments, the patterned texture can be or is formed with a grit material embedded in the backing, a rubber based material, a silicon based material and combinations thereof. For the embodiments, the backing can include perforations to allow air to pass between the first major surface and the second major surface as the face sheet is applied to the paddleball paddle.

Embodiments of the present disclosure also include a pickleball paddle that includes: a core structure having handle and a hitting surface; and a face sheet of any one of the embodiments provided herein, where the face sheet is releasably positioned over the hitting surface of the pickleball paddle.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 shows an exploded view of an embodiment of a pickleball paddle.

FIGS. 2A and 2B show embodiments of a face sheet according to an embodiment of the present disclosure.

FIGS. 2A and 2B show embodiments of a face sheet according to an embodiment of the present disclosure.

FIGS. 3A and 3B show embodiments of a face sheet according to an embodiment of the present disclosure.

FIGS. 4A and 4B show embodiments of a face sheet according to an embodiment of the present disclosure.

FIGS. 5A and 5B show embodiments of a face sheet according to an embodiment of the present disclosure.

FIGS. 6A and 6B show embodiments of a face sheet according to an embodiment of the present disclosure.

FIG. 7 shows an embodiment of a pickleball paddle with an embodiment of the face sheet according to embodiments of the present disclosure.

### DETAILED DESCRIPTION

The following detailed description is of the best currently contemplated modes of carrying out exemplary embodiments of the disclosure. The description is not to be taken in a limiting sense but is made merely for the purpose of illustrating the general principles of the present disclosure.

As used herein, “a,” “an,” “the,” “at least one,” and “one or more” are used interchangeably. The term “and/or” means one, one or more, or all of the listed items. The recitations of numerical ranges by endpoints include all numbers subsumed within that range (e.g., 1 to 5 includes 1, 1.5, 2, 2.75, 3, 3.80, 4, 5, etc.).

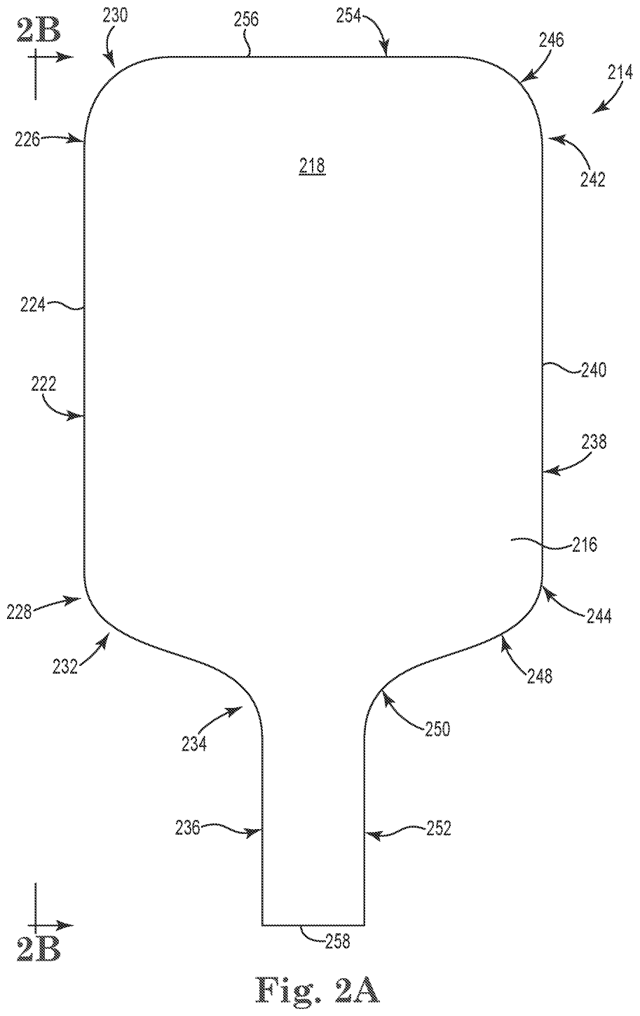

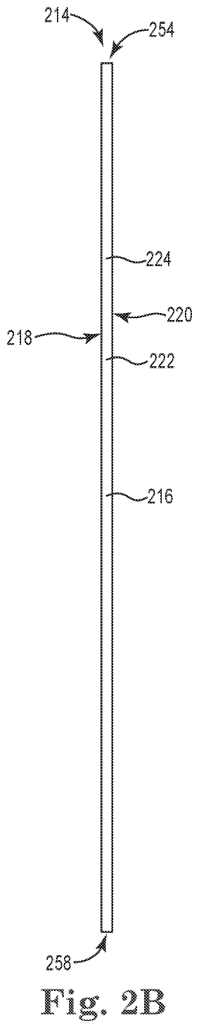

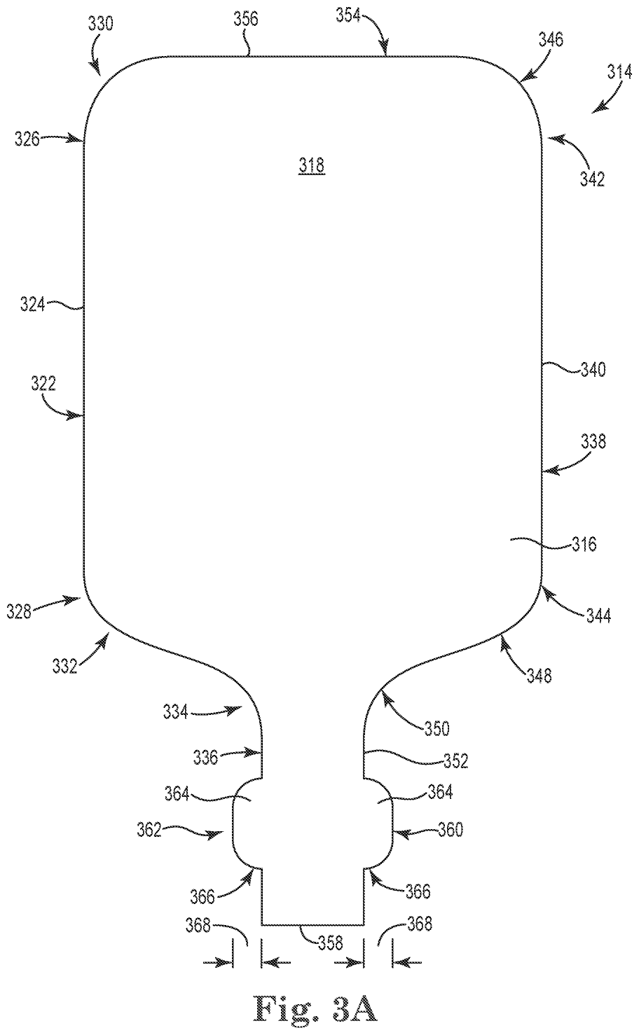

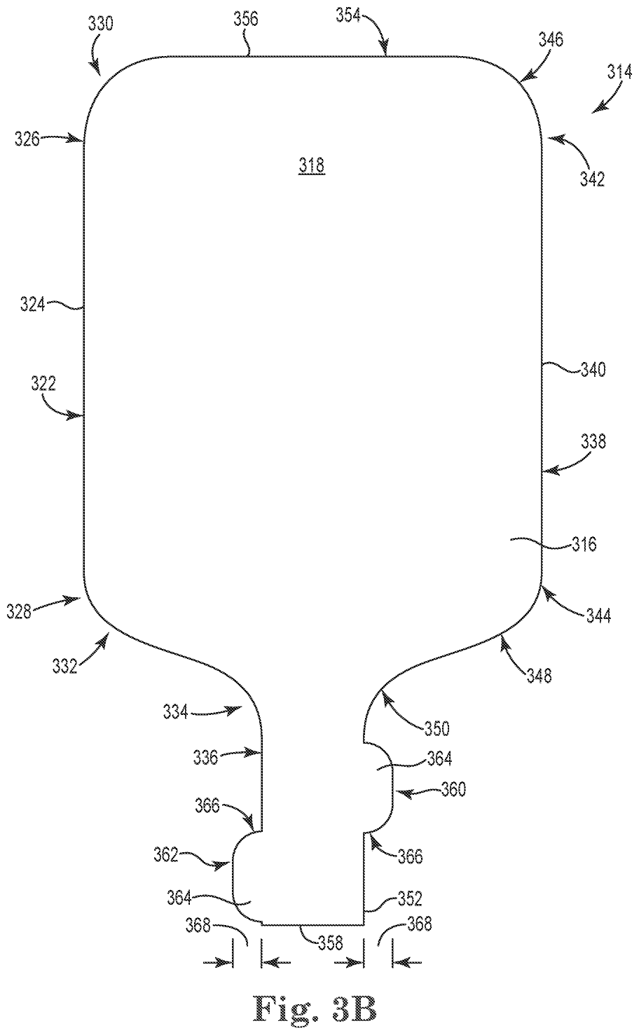

The figures herein follow a numbering convention in which the first digit or digits correspond to the drawing figure number and the remaining digits identify an element in the drawing. Similar elements between different figures may be identified by the use of similar digits. For example, 216 may reference element “16” in FIG. 2, and a similar element may be referenced as 316 in FIG. 3. It is emphasized that the purpose of the figures is to illustrate and the figures are not intended to be limiting in any way. The figures herein may not be to scale and relationships of elements in the figures may be exaggerated. The figures are employed to illustrate conceptual structures and methods herein described.

As previously stated, pickleball paddles wear down over time due to stress and there are no available means and processes by which to repair pickleball paddles.

Presented herein is a face sheet, also referred to as a pickleball carrier, having a backing with a patterned texture on at least a portion of a first major surface of the backing of the face sheet (a textured paddle face surface) and, in embodiments, an adhesive material on at least a portion of a second major surface of the backing (an adhesive non-paddle face surface for integration with a pickleball paddle core). The present disclosure includes, in various embodiments, an adhesive back composite or paper of the face sheet, or any other thin surface materials with a variety of textures, that may be adhered to a paddle surface of pickleball paddles, and paddles that are used playing the game pickleball, so as to resurface the paddle is disclosed. It's a brand-new surface area, where other options don't exist.

As discussed herein, the face sheet (pickleball carriers) can be manufactured in the shape of pickleball paddles. As discussed herein, the face sheet can include a backing having a first major surface and a second major surface (a pickleball carrier can comprise a first side and a second side) made of a variety of materials discussed herein, e.g., fiberglass (composite), graphite and carbon fiber sheets, among others. The face sheet (pickleball carrier, the first side, the second side, or any combination thereof) has a preferred thickness or thicknesses. The preferred thickness can be dependent on performance, competition rules, or both. Thicknesses are discussed herein.

The first major surface (first side) and the second major surface (second side) of the backing help to define a paddle face surface (first major surface) and a non-paddle face surface (second major surface). As discussed herein, the non-paddle face surface (at least a portion of the second major surface) of each side can be coated with an adhesive, such as glue, cement, or both, and the paddle face surface (at least a portion of the first major surface) of each side can be textured according to a particular design. These aspects will be discussed more fully herein.

In an embodiment, the adhesive can be applied after market and sold as a separate item from the face sheet (pickleball carrier).

In another embodiment, the face sheet (pickleball carrier) (e.g., the backing of the face sheet among other parts) can be manufactured using a 3D printing process. The use of 3D printing is known in the art.

In yet another embodiment, the paddle face surface (the first major surface of the backing of the face sheet) can be textured using a 3D printing process and a stencil design.

### Further Discussion of the Face Sheet (Pickleball Carrier)

A version of the face sheet (pickleball carrier) discussed here includes:
1. An adhesive backed sticker with many surface material textures
2. Multiple options, surface texture grit and other material compounds
3. A tab for easy removal and or spray to release adhesive

### Relationship Between Components:

1. Sticker like application
2. Adheres to a Pickleball paddle face for both sides of paddle
3. Many surface materials as an option
4. Includes easy remove tab

### An Embodiment of how the Face Sheet (Pickleball Carrier) Works:

You remove the backing of a sticker/similar product, that contains grit and or other commonly used paddle face materials. You adhere the sticker to the face of paddle and are then able to use your paddle to play the sport of pickleball.

### Embodiments on how to Make the Face Sheet (Pickleball Carrier):

Face sheets (pickleball carriers) can be manufactured in the shape of pickleball paddles. A face sheet (pickleball carrier) can comprise a backing having a first major surface (first side) and a second major surface (second side) made of, e.g., fiberglass (composite), graphite and carbon fiber sheets, among others, with the carrier, the first side, the second side, or any combination thereof, having a preferred thickness or thicknesses. The preferred thickness can be dependent on performance, competition rules, or both.

The first major surface (first side) and the second major surface (second side) can be referred to, in various embodiments, as a paddle face surface and a non-paddle face surface. The second major surface (the non-paddle face surface) of each side can be coated with an adhesive, such as glue, cement, or both, and the first major surface (the paddle face surface) of each side can be textured according to a particular design.

### How to Use the Face Sheet (Pickleball Carrier):

A pickleball paddle having a damaged surface can be resurfaced by removing a layer of a certain thickness from the paddle face surface, or the entire paddle face surface, and cleaning the remaining surface layer. Cleaning can be accomplished with chemical, heat and/or mechanical techniques.

The second major surface of the backing (non-paddle face surface) of a face sheet (pickleball carrier) can be coated with an adhesive and applied to the cleaned, remaining surface layer. The first major surface (textured paddle face surface) now become the new pickleball paddle hitting surface.

It should be understood, of course, that the present disclosure relates to exemplary embodiments of the invention and that modifications may be made without departing from the spirit and scope of the present invention.

As discussed, the present disclosure provides for means and processes to repair pickleball paddles. In particular, the present disclosure provides for means and processes to repair pickleball paddles that is both easy enough and inexpensive enough to be achievable by most anyone. The present disclosure includes the followings aspects:
Aspect 1. A face sheet for resurfacing a pickleball paddle, the face sheet comprising:
   a backing having a first major surface and a second major surface opposite the first major surface, where the first major surface and the second major surface include:
      a first major edge having a first major linear portion extending between a first end and a second end, a first convex corner extending from the first end, a second convex corner extending from the second end, a first concave corner extending from the second convex corner and a first minor edge portion extending from the second convex corner away from both the first end and the second end of the first major linear portion;
      a second major edge having a second major linear portion extending between a third end and a fourth end, a third convex corner extending from the third end, a fourth convex corner extending from the fourth end, a second concave corner extending from the fourth convex corner and a second minor edge portion extending from the fourth convex corner away from both the third end and the fourth end of the second major linear portion;
      a third major edge having a third major linear portion extending between the first convex corner of the first major edge and the third convex corner of the second major edge;
      a first minor edge extending between the first minor edge portion and the second minor edge portion;
      a first tab extending from the first minor edge portion of the first major edge; and
      a second tab extending from the second minor edge portion of the second major edge; and
a patterned texture on at least a portion of the first major surface to provide grip against a surface of a pickleball being struck by the pickleball paddle having the face sheet.
Aspect 2. The face sheet of Aspect 1, further including an adhesive material on at least a portion of the first tab and the second tab.
Aspect 3. The face sheet of any one of Aspects 1-2, where the first tab and the second tab are covered with the adhesive material.
Aspect 4. The face sheet of Aspect 1, where the first tab includes a first surface defining hook structures and the second tab includes a second surface defining loop structures that releasably engage with the hook structures of the first surface.
Aspect 5. The face sheet of any one of Aspects 1-4, where the backing further includes a reinforcement strip that extends from the third major edge and the first minor edge.
Aspect 6. The face sheet of Aspect 5, where the reinforcement strip extends adjacent to the first major edge, the second major edge and the third major edge to a position between the first tab and the second tab.
Aspect 7. A face sheet for resurfacing a pickleball paddle, the face sheet comprising:
   a backing having a first major surface and a second major surface opposite the first major surface, where the first major surface and the second major surface include:
      a first major edge having a first major linear portion extending between a first end and a second end, a first convex corner extending from the first end, a second convex corner extending from the second end, a first concave corner extending from the second convex corner and a first minor edge portion extending from the second convex corner away from both the first end and the second end of the first major linear portion;
      a second major edge having a second major linear portion extending between a third end and a fourth end, a third convex corner extending from the third end, a fourth convex corner extending from the fourth end, a second concave corner extending from the fourth convex corner and a second minor edge portion extending from the fourth convex corner away from both the third end and the fourth end of the second major linear portion;
      a third major edge having a third major linear portion extending between the first convex corner of the first major edge and the third convex corner of the second major edge;
      a first minor edge extending between the first minor edge portion and the second minor edge portion; and
      a reinforcement strip that extends from the third major edge and the first minor edge; and
a patterned texture on at least a portion of the first major surface to provide grip against a surface of a pickleball being struck by the pickleball paddle having the face sheet.
Aspect 8. The face sheet of Aspect 7, where the reinforcement strip extends adjacent to the first major edge, the second major edge and the third major edge to a position between the first tab and the second tab.
Aspect 9. The face sheet of any one of Aspects 7-8, where the backing includes:
a first tab extending from the first minor edge portion of the first major edge; and
a second tab extending from the second minor edge portion of the second major edge.
Aspect 10. The face sheet of any one of Aspect 9, further including an adhesive material on at least a portion of the first tab and the second tab.
Aspect 11. The face sheet of any one of Aspects 9-10, where the first tab and the second tab are covered with the adhesive material.
Aspect 12. The face sheet of Aspect 9, where the first tab includes a first surface defining hook structures and the second tab includes a second surface defining loop structures that releasably engage with the hook structures of the first surface.
Aspect 13. The face sheet of any one of Aspects 1-12, further including an adhesive material on at least a portion of the second major surface of the backing, where the adhesive material helps to secure the face sheet to the pickleball paddle.
Aspect 14. The face sheet of Aspect 13, where the adhesive material is not present between the first minor edge portion and the second minor edge portion of the backing.
Aspect 15. The face sheet of Aspect 13, where the adhesive material is selected from the group consisting of contact cement, a thermoplastic based adhesive, a cyanoacrylate based adhesive, a polyurethane based adhesive, a pressure-sensitive adhesive, an acrylic-based adhesive, a rubber-based adhesive, a hot-melt adhesive and combinations thereof.
Aspect 16. The face sheet of any one of Aspects 1-15, where the backing is formed of graphite, carbon fiber, fiberglass, aramid fiber, a thermoplastic film, wood pulp, a woven fabric, a felted fabric and combinations thereof.
Aspect 17. The face sheet of any one of Aspects 1-16, where the patterned texture is formed with a grit material embedded in the backing, a rubber based material, a silicon based material and combinations thereof.
Aspect 18. The face sheet of any one of Aspects 1-17, where the backing includes perforations to allow air to pass between the first major surface and the second major surface as the face sheet is applied to the paddleball paddle.
Aspect 19. A pickleball paddle, comprising:
a core structure having handle and a hitting surface; and
a face sheet of any one of Aspects 1-18 releasably positioned over the hitting surface of the pickleball paddle.
Aspect 20. A face sheet for resurfacing a pickleball paddle, the face sheet comprising:
   a backing having a first major surface and a second major surface opposite the first major surface, where the first major surface and the second major surface include:
      a first major edge having a first major linear portion extending between a first end and a second end, a first convex corner extending from the first end, a second convex corner extending from the second end, a first concave corner extending from the second convex corner and a first minor edge portion extending from the second convex corner away from both the first end and the second end of the first major linear portion;
      a second major edge having a second major linear portion extending between a third end and a fourth end, a third convex corner extending from the third end, a fourth convex corner extending from the fourth end, a second concave corner extending from the fourth convex corner and a second minor edge portion extending from the fourth convex corner away from both the third end and the fourth end of the second major linear portion;
      a third major edge having a third major linear portion extending between the first convex corner of the first major edge and the third convex corner of the second major edge; and
      a first minor edge extending between the first minor edge portion and the second minor edge portion; and
a patterned texture on at least a portion of the first major surface to provide grip against a surface of a pickleball being struck by the pickleball paddle having the face sheet.
Aspect 21. The face sheet of Aspect 20, where the first minor edge portion and the second minor edge portion of the backing are mirror images of each other.
Aspect 22. The face sheet of any one of Aspects 20-21, where the first minor edge of the backing is at least seventy (70) percent shorter than the third major edge.
Aspect 23. The face sheet of any one of Aspects 20-22, where the backing further includes a first tab extending from the first minor edge portion of the first major edge; and
   a second tab extending from the second minor edge portion of the second major edge.
Aspect 24. The face sheet of any one of Aspects 20-23, where the backing further includes a reinforcement strip that extends adjacent the first major edge, the second major edge and the third major edge to a position between the first tab and the second tab.
Aspect 25. The face sheet of any one of Aspects 20-24, further including an adhesive material on at least a portion of the second major surface of the backing, where the adhesive material helps to secure the face sheet to the pickleball paddle.
Aspect 26. The face sheet of Aspect 25, where the adhesive material is not present between the first minor edge portion and the second minor edge portion of the backing.
Aspect 27. The face sheet of any one of Aspects 25-26, where the adhesive material is not present on the first tab or the second tab.
Aspect 28. The face sheet of Aspect 25, where the adhesive material is selected from the group consisting of contact cement, a thermoplastic based adhesive, a cyanoacrylate based adhesive, a polyurethane based adhesive, a pressure-sensitive adhesive, an acrylic-based adhesive, a rubber-based adhesive, a hot-melt adhesive and combinations thereof.
Aspect 29. The face sheet of Aspect 25, further including a releasable cover sheet over the adhesive material.
Aspect 30. The face sheet of any one of Aspects 20-29, where the backing is formed of graphite, carbon fiber, fiberglass, aramid fiber, a thermoplastic film, wood pulp, a woven fabric, a felted fabric and combinations thereof.
Aspect 31. The face sheet of any one of Aspects 20-30, where the patterned texture includes a grit material embedded in the backing, where the grit material has a grit number in a range of 60 to 120.
Aspect 32. The face sheet of any one of Aspects 20-31, where the patterned texture is formed with a rubber based material, a silicon based material and combinations thereof.
Aspect 33. The face sheet of any one of Aspects 20-32, where the backing includes perforations to allow air to pass between the first major surface and the second major surface as the face sheet is applied to the paddleball paddle.
Aspect 34. The face sheet of any one of the previous aspects 1-33, where the backing includes a first alinement guide and the second alignment guide, where the first alignment guide and the second alinement guide are physically separated from each other and are located between the first major edge, the second major edge and the third major edge, wherein the first alinement guide and the second alignment guide assist with positioning the face sheet on the pickleball paddle.
Aspect 35. A pickleball paddle, comprising:
   a core structure having handle and a hitting surface; and
   a face sheet of any one of Aspects 20-34 releasably positioned over the hitting surface of the pickleball paddle.

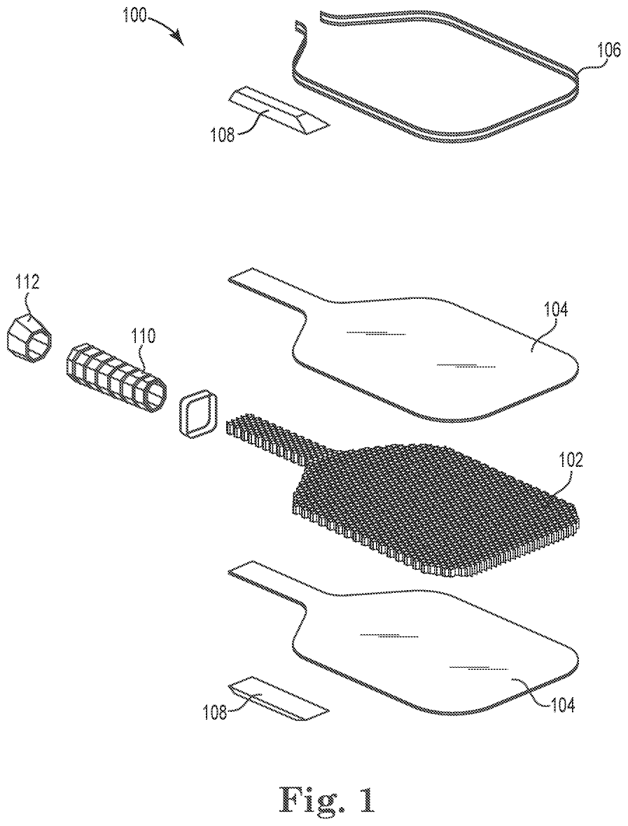

A pickleball paddle typically consists of several components, each contributing to the overall design and performance of the paddle. An embodiment of a pickleball paddle 100 is shown in FIG. 1, where the pickleball paddle 100 is shown in an exploded view to illustrate various parts of the pickleball paddle 100. As illustrated in FIG. 1, the pickleball paddle 100 includes a core 102, a face 104 that can be positioned on either side of the core 102 (e.g., can sandwich at least a portion of the core 102), an edge guard 106, a handle 108, a grip 110, and a butt cap 112. The following is a brief description of these parts of the pickleball paddle 100.

The core 102 is the inner part of the pickleball paddle 100 and is situated between two of the faces 104. The core 102 can be made of various materials, such as polymer (e.g., polypropylene, polyethylene or ethylene vinyl acetate foam), Nomex®, aluminum (e.g., an aluminum honeycomb) and/or wood, among other materials. The material of the core 102 is shaped and molded according to the design specifications of the pickleball paddle 100.

The face 104 of the pickleball paddle 100 comes into direct contact with the pickleball during play. As is known in the art, the face 104 can be made of a composite material such as graphite, carbon fiber, Kevlar, fiberglass, or a combination of both, where combinations of these materials may be used and/or laminated together for strength and durability. Some pickleball paddles 100 also have a polymer core in the face 104. The face 104 can also include a textured or rough surface to allow for spin to be applied to the pickleball during play. Typically, the material used to make the face 104 is cut and shaped to match the design and shape of the pickleball paddle 100.

During the initial construction of the pickleball paddle 100, the face 104 is applied to the core 102 of the pickleball paddle 100. For example, once the core 102 is prepared and shaped according to the pickleball paddle 100 design the face 104 is cut and shaped to match the design specifications of the pickleball paddle 100. Multiple layers of the materials provided herein may be laminated together to achieve the desired thickness and performance characteristics of the face 104. An adhesive suitable for bonding the core 102 and face 104 materials is applied to both surfaces and the face 104 material is aligned with the core 102 so as to cover the entire surface evenly. Once aligned, pressure is applied to the face-material-and-core assembly to bond the face 104 to the core 102. Examples of adhesives used in the manufacture of the pickleball paddle 100 can include epoxy resins, polyurethane adhesives, cyanoacrylates, contact cement and heat activated adhesives, as are known in the art.

The edge guard 106 is a protective strip that surrounds the perimeter of the pickleball paddle 100 and helps to prevent damage to the pickleball paddle 100 from accidental collisions with the court or other paddles. The edge guard 106 can be made with a durable material like polyvinyl chloride or other similar high-impact polymers. The edge guard 106 is attached to the perimeter of the pickleball paddle 100, usually with a combination of adhesive and mechanical fasteners like screws or rivets. It is appreciated that some pickleball paddles do not include an edge guard.

The handle 108 is the part of the pickleball paddle 100 that a player hold during play. The handle 108 connects the grip 110 to the rest of the pickleball paddle 100. The handle 108 can have a variety of shapes (e.g., oval, rectangular, etc.) and comes in sizes to accommodate different player preferences. The handle 108 of the pickleball paddle 100 is typically wrapped with the grip 110, which is made of a material to provide comfort and enhance the player's grip during play. Common materials used for the grip 110 include cushioned synthetic materials such as polyurethane, synthetic leather, or a combination of materials. The grip 110 often has a cushioned or tacky feel, providing a comfortable and secure hold. The grip 110 can also include perforations and/or further include an overgrip, as are known.

The butt cap 112 is located at the bottom end of the handle 108 and serves as a cap or seal for the handle 108 and provides a finishing touch to the paddle.

Referring now to FIGS. 2A and 2B, there is shown an embodiment of the face sheet 214 of the present disclosure. As illustrated in FIGS. 2A and 2B, the face sheet 214 includes a backing 216 having a first major surface 218 and a second major surface 220 opposite the first major surface 218. The first major surface 218 and the second major surface 220 include a first major edge 222 having a first major linear portion 224 extending between a first end 226 and a second end 228. The backing 216 further includes a first convex corner 230 extending from the first end 226, a second convex corner 232 extending from the second end 228, a first concave corner 234 extending from the second convex corner 232 and a first minor edge portion 236 extending from the second convex corner 232 away from both the first end 226 and the second end 228 of the first major linear portion 224. The backing 216 also includes a second major edge 238 having a second major linear portion 240 extending between a third end 242 and a fourth end 244, a third convex corner 246 extending from the third end 242, a fourth convex corner 248 extending from the fourth end 244, a second concave corner 250 extending from the fourth convex corner 248 and a second minor edge portion 252 extending from the fourth convex corner 248 away from both the third end 242 and the fourth end 244 of the second major linear portion 240. The backing 216 further includes a third major edge 254 having a third major linear portion 256 extending between the first convex corner 230 of the first major edge 222 and the third convex corner 246 of the second major edge 238. The backing 216 also includes a first minor edge 258 extending between the first minor edge portion 236 and the second minor edge portion 252. The backing 216 further includes a patterned texture, as discussed herein, on at least a portion of the first major surface 218 to provide grip against a surface of a pickleball being struck by the pickleball paddle having the face sheet 214.

As illustrated in FIG. 2A, the first minor edge portion 236 and the second minor edge portion 252 of the backing 216 are, or can be, mirror images of each other. In addition, for the various embodiments the first minor edge 258 of the backing 216 is shorter than the third major edge 254. For example, the first minor edge 258 of the backing 216 can be at least seventy (70) percent shorter than the third major edge 254. In another embodiment, the first minor edge 258 of the backing 216 can be at least eighty (80) percent shorter than the third major edge 254. In another embodiment, the first minor edge 258 of the backing 216 can be seventy (70) to ninety (90) percent shorter than the third major edge 254. This description of the relative size of the first minor edge 258 of the backing 216 being shorter than the third major edge 254 is applicable to the other face sheet descriptions below (e.g., FIGS. 3A, 3B, 4A, 4B, 5A and 5B).

Referring now to FIGS. 3A and 3B, there is shown an additional embodiment of the face sheet 314 according to the present disclosure. As illustrated, the face sheet 314 includes backing 316, first major surface 318, second major surface 320, first major edge 322, first major linear portion 324, first end of first major linear portion 326, second end 328 of first major linear portion 324, first convex corner 330 of the first major linear portion 324, second convex corner 332 of the first major linear portion 324, first concave corner 334 of the first major linear portion 324, first minor edge portion 336, second major edge 338, second major linear portion 340, third end 342 of the second major linear portion 340, fourth end 344 of the second major linear portion 340, third convex corner 346 of the second major linear portion 340, fourth convex corner 348 of the second major linear portion 340, second concave corner 350 of the second major linear portion 340, second minor edge portion 352 of the second major linear portion 340, third major edge 354, third major linear portion 356 and first minor edge 358, each as discussed herein.

In addition, for the embodiments the backing 316 further includes a first tab 360 extending from the first minor edge portion 336 of the first major edge 322 and a second tab 362 extending from the second minor edge portion 352 of the second major edge 338. As illustrated, each of the first tab 360 and the second tab 362 are a portion of the backing 316, in one embodiment, that projects from the respective minor edge portions, as discussed herein. In alternative embodiment, the first tab 360 and the second tab 362 are attached or joined to the backing 316, where the first tab 360 and the second tab 362 can be made of the same or different material than the backing 316. Attaching the first tab 360 and the second tab 362 to the backing 316 can be accomplished with a chemical adhesive, such as a cyanoacrylate or other know chemical adhesives, including those discussed herein, mechanical and/or thermomechanical techniques such as fusing or melt bonding the first tab 360 and the second tab 362 to the backing 316.

The first tab 360 and the second tab 362 can each include a first side tab surface 364 and a second side tab surface 366, where the first side tab surface 364 is on the same side of the backing 316 as the first major surface 318 and the second side tab surface 366 is on the same side of the backing 316 as the second major surface 320. For the embodiments, the face sheet 314 can further include an adhesive material, as discussed herein, on at least a portion of the first tab 360 and the second tab 362. For example, the first tab 360 and the second tab 362 can be covered with the adhesive material. In other words, the adhesive material can be present on both the first side tab surface 364 and the second side tab surface 366 of a given face sheet 314. In an additional embodiment, the first side tab surface 364 can include the adhesive material while the second side tab surface 366 does not include the adhesive material. In a further embodiment, the first side tab surface 364 of the first tab 360 can define hook structures and the second side tab surface 366 of the second tab 362 can define loop structures that releasably engage with the hook structures of the first side tab surface 364. The hook and loop fastening structures can be micro scale, as are known, and optionally include a pressure sensitive adhesive integrated into the structures.

As illustrated in FIG. 3A, the first minor edge portion 336 and the second minor edge portion 352 of the backing 316 are, or can be, mirror images of each other. The projection of the first tab 360 and the second tab 362, from their respective first minor edge portion 336 and the second minor edge portion 352, can also have a lateral dimension 368 that allows for the first side tab surface 364 of a first of the face sheet 314 positioned on a first major surface of the core of the pickleball paddle to at least partially cover the second side tab surface 366 of a second of the face sheet 314 on a second major surface of the core of the pickleball paddle. In this embodiment, the first tab 360 and the second tab 362 would be wrapped at least partially around the handle and a portion of the core (both as seen in FIG. 1) of the pickleball paddle.

In an alternative embodiment, the first tab 360 and the second tab 362 are not mirror images of each other, but rather have a staggered relative position from their respective first minor edge portion 336 and the second minor edge portion 352 (FIG. 3B). Such an embodiment allows for the first tab 360 and the second tab 362 of a first of the face sheet 314 to be wrapped at least partially around the handle and a portion of the core (both as seen in FIG. 1) of the pickleball paddle so as to be positioned adjacent the first tab 360 and the second tab 362 of a second of the face sheet 314 also wrapped at least partially around the handle and a portion of the core (both as seen in FIG. 1) of the pickleball paddle. An example of this embodiment of the face sheet 314 is illustrated in FIG. 3B.

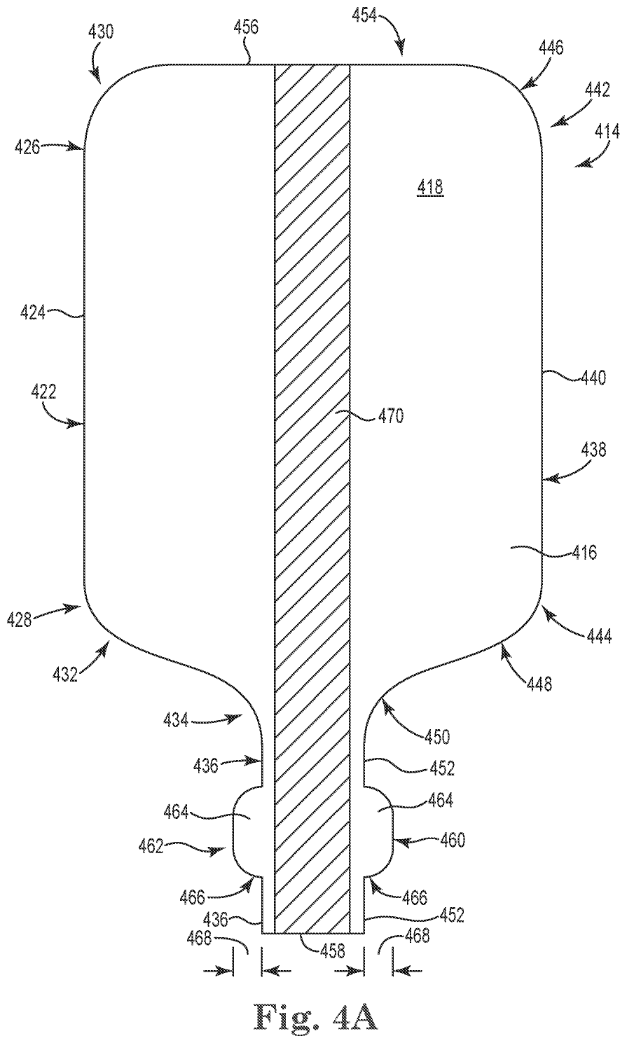

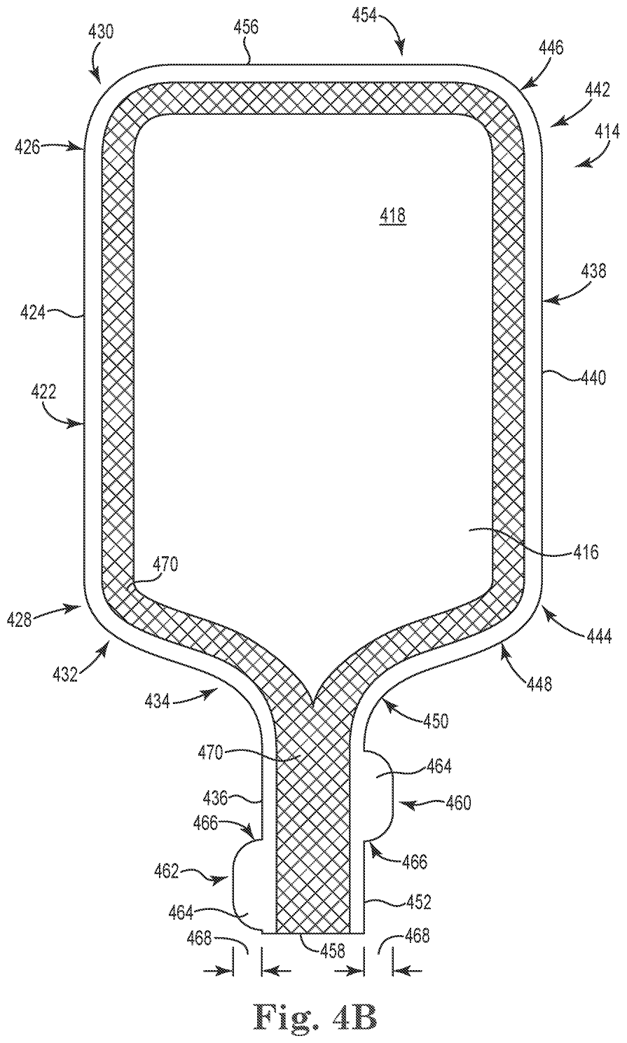

Referring now to FIGS. 4A and 4B, there is illustrated an embodiment of the face sheet 414 of the present disclosure as discussed for FIGS. 3A and 3B in which the backing 416 further include a reinforcement strip 470. As illustrated in FIG. 4A the reinforcement strip 470 extends from the third major edge 454 and the first minor edge 458. As illustrated in FIG. 4B the reinforcement strip 470 extends adjacent to the first major edge 422, the second major edge 438 and the third major edge 454 to a position between the first tab 460 and the second tab 462.

With respect to FIGS. 4A and 4B, the first tab 460 extending from the first minor edge portion 436 of the first major edge 422 and the second tab 462 extending from the second minor edge portion 452 of the second major edge 438. As illustrated, each of the first tab 460 and the second tab 462 are a portion of the backing 416, in one embodiment, that projects from the respective minor edge portions, as discussed herein. In alternative embodiment, the first tab 460 and the second tab 462 are attached or joined to the backing 416, where the first tab 460 and the second tab 462 can be made of the same or different material than the backing 416. Attaching the first tab 460 and the second tab 462 to the backing 416 can be accomplished with a chemical adhesive, such as a cyanoacrylate or other know chemical adhesives, including those discussed herein, mechanical and/or thermomechanical techniques such as fusing or melt bonding the first tab 460 and the second tab 462 to the backing 416.

The first tab 460 and the second tab 462 can each include a first side tab surface 464 and a second side tab surface 466, where the first side tab surface 464 is on the same side of the backing 416 as the first major surface 418 and the second side tab surface 466 is on the same side of the backing 416 as the second major surface 420. For the embodiments, the face sheet 414 can further include an adhesive material, as discussed herein, on at least a portion of the first tab 460 and the second tab 462. For example, the first tab 460 and the second tab 462 can be covered with the adhesive material. In other words, the adhesive material can be present on both the first side tab surface 464 and the second side tab surface 466 of a given face sheet 414. In an additional embodiment, the first side tab surface 464 can include the adhesive material while the second side tab surface 466 does not include the adhesive material. In a further embodiment, the first side tab surface 464 of the first tab 460 can define hook structures and the second side tab surface 466 of the second tab 462 can define loop structures that releasably engage with the hook structures of the first side tab surface 464. The hook and loop fastening structures can be micro scale, as are known, and optionally include a pressure sensitive adhesive integrated into the structures.

As illustrated in FIG. 4A, the first minor edge portion 436 and the second minor edge portion 452 of the backing 416 are, or can be, mirror images of each other. The projection of the first tab 460 and the second tab 462, from their respective first minor edge portion 436 and the second minor edge portion 452, can also have a lateral dimension 468 that allows for the first side tab surface 464 of a first of the face sheet 414 positioned on a first major surface of the core of the pickleball paddle to at least partially cover the second side tab surface 466 of a second of the face sheet 414 on a second major surface of the core of the pickleball paddle. In this embodiment, the first tab 460 and the second tab 462 would be wrapped at least partially around the handle and a portion of the core (both as seen in FIG. 1) of the pickleball paddle.

In an alternative embodiment, the first tab 460 and the second tab 462 are not mirror images of each other, but rather have a staggered relative position from their respective first minor edge portion 436 and the second minor edge portion 452 (FIG. 4B). Such an embodiment allows for the first tab 460 and the second tab 462 of a first of the face sheet 414 to be wrapped at least partially around the handle and a portion of the core (both as seen in FIG. 1) of the pickleball paddle so as to be positioned adjacent the first tab 460 and the second tab 462 of a second of the face sheet 414 also wrapped at least partially around the handle and a portion of the core (both as seen in FIG. 1) of the pickleball paddle. An example of this embodiment of the face sheet 414 is illustrated in FIG. 4B.

Examples of the reinforcement strip 470 can include reinforcement fibers integrated into or on to the backing 416 in a predetermined pattern, where the fibers can be made of fiberglass and/or polyester, among other materials. The reinforcement fibers help to provide additional strength to the backing 416 to help better ensure the backing 416 can be removed in a single piece when being replaced (e.g., the reinforcement strip acts to increase the tensile strength of the backing 416 to help to prevent the backing 416 from tearing in higher stress areas or under tension when the backing 416 is being replaced or removed).

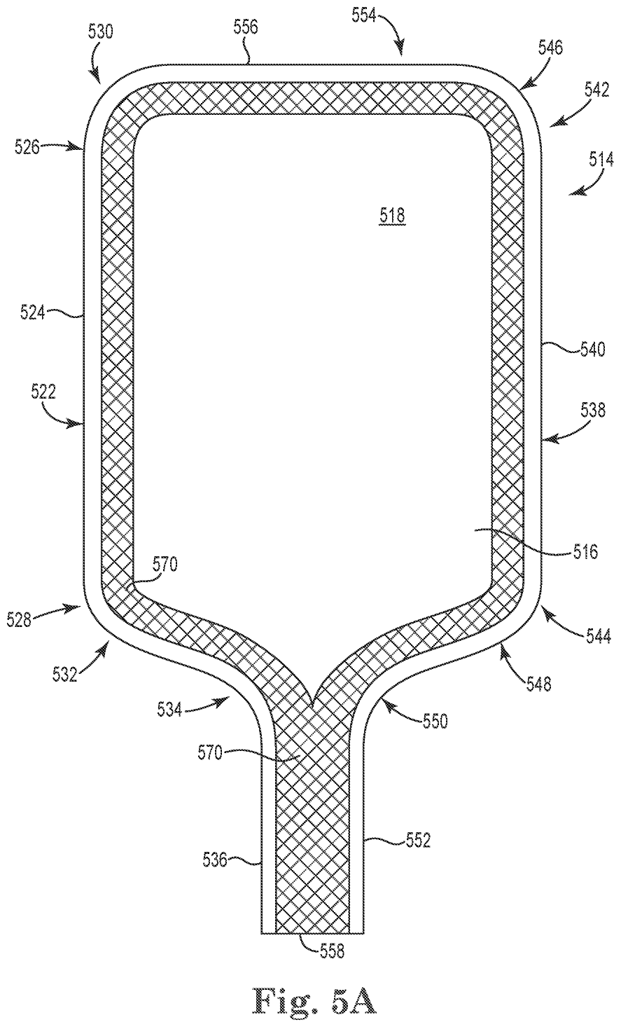

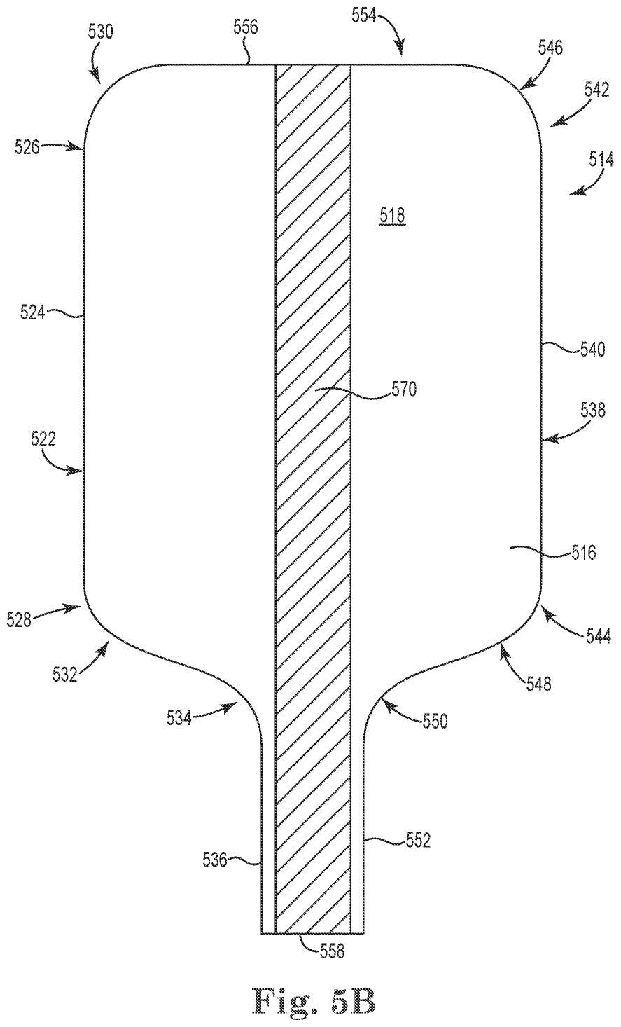

Referring now to FIGS. 5A and 5B there is shown additional embodiments of the face sheet 514 of the present disclosure. As illustrated, the face sheet 514 includes backing 516, first major surface 518, second major surface 520, first major edge 522, first major linear portion 524, first end of first major linear portion 526, second end 528 of first major linear portion 524, first convex corner 530 of the first major linear portion 524, second convex corner 532 of the first major linear portion 524, first concave corner 534 of the first major linear portion 524, first minor edge portion 536, second major edge 538, second major linear portion 540, third end 542 of the second major linear portion 540, fourth end 544 of the second major linear portion 540, third convex corner 546 of the second major linear portion 540, fourth convex corner 548 of the second major linear portion 540, second concave corner 550 of the second major linear portion 540, second minor edge portion 552 of the second major linear portion 540, third major edge 554, third major linear portion 556 and first minor edge 558, each as discussed herein. In addition, for the embodiments the backing 516 further includes a reinforcement strip 570, as discussed herein (e.g., FIGS. 4A and 4B), that extends from the third major edge 554 and the first minor edge 558 (FIG. 5A). In an alternative embodiment, the reinforcement strip 570 extends adjacent to the first major edge 522, the second major edge 538 and the third major edge 554 to a position between the first tab 560 and the second tab 562 (FIG. 5B).

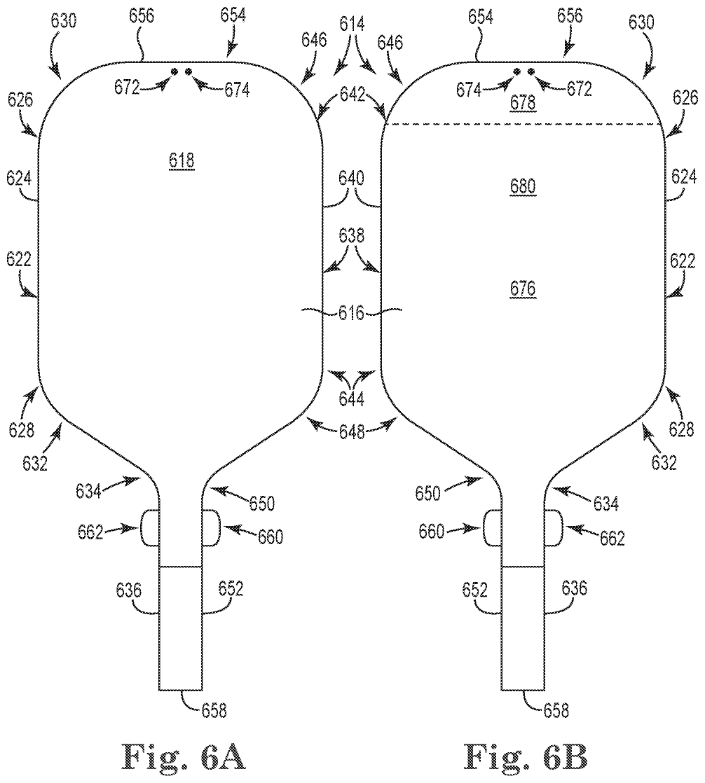

Referring now to FIGS. 6A and 6B, there is shown an embodiment of the present disclosure that includes an additional embodiment of the present disclosure. FIGS. 6A and 6B illustrate an embodiment in which the backing 616 of a face sheet 614 according to any one of the previous embodiments provided herein (214, 314, 414, 514, 216, 316, 416, 516) can further include a first alinement guide 672 and a second alignment guide 674, where the first alignment guide 672 and the second alinement guide 674 are physically separated from each other and are located between the first major edge 622, the second major edge 638 and the third major edge 654. In other words, the first alignment guide 672 and the second alinement guide 674 are not nor do they form a part of the first major edge 622, the second major edge 638 and the third major edge 654. For the various embodiments, the first alinement guide 672 and the second alignment guide 674 assist with positioning the face sheet on the pickleball paddle, as described herein.

For the various embodiments, the first alinement guide 672 and the second alignment guide 674 can be used in making guiding marks on the core of the pickleball paddle in need of a new face sheet, which along with the first major edge 622, the second major edge 638 and the third major edge 654 better ensures that the various parts of the face sheet 614 provided herein (e.g., the first major edge 622, the second major edge 638, first minor edge portion 636, second minor edge portion 652) precisely aligns with the various parts of the core as the face sheet 614 is being secured to the pickleball paddle when being resurfaced with the face sheet 614.

As appreciated, when securing the face sheet 614 to the core one would typically attempt to align the major features of the face sheet 614 with the corresponding and appropriate portions of the core of the pickleball paddle. So, for example, one might attempt to initially align the third major edge 654 of the face sheet 614 with the corresponding major edge of the core that is opposite the butt cap of the pickleball paddle. After removing a releasable cover sheet over the adhesive material (discussed more fully herein) one might progress in pressing and securing the face sheet 614 starting at or near the above noted third major edge 654 of the face sheet 614 and progressing towards the first minor edge 658 only to find that the initial alignment has caused the face sheet 614 not to be suitable aligned with the other major features (e.g., the edges) of the core of the pickleball paddle. To this end, the first alinement guide 672 and the second alignment guide 674 provide at least a second and a third point of reference set apart not only from each other but also from the first major edge 622, the second major edge 638 and the third major edge 654. Having these additional guides along with at least a major feature of the face sheet 614 (e.g., the third major edge 654) one can better ensure the face sheet 614 precisely aligns with the core as the face sheet 614 is being secured to the pickleball paddle.

For the various embodiments, the first alinement guide 672 and the second alignment guide 674 can each take the form of a hole, where each hole is defined by a surface extending between the first major surface 618 and the second major surface 620 of the backing 616 of the face sheet 614. For the various embodiments, each hole of the first alinement guide 672 and the second alignment guide 674 can be individually selected from the following shapes: round, oval, triangular, square, rectangular, wavey, linear, non-geometric and polygonal, among other known shapes. Examples of other structures for the first alinement guide 672 and the second alignment guide 674 can include, but are not limited to, markings and/or other observable differences by eyesight and or touch. These can be physically cut holes (as discussed), indentations, different translucency in backing 616 material, etc. These identifiable characteristics aid in easy alignment and serve as a guide for application of the face sheet 614 to the core of the pickleball paddle.

So, in resurfacing a pickleball paddle the face sheet 614 can be placed on the core of the pickleball paddle to which it will be secured (prior to exposing the adhesive material) so that major features of the face sheet 614 precisely align with the corresponding major features of the core. Once the proper alignment is achieved the first alinement guide 672 and the second alignment guide 674 can be used in making guiding marks on the core of the pickleball paddle. For example, when each of the first alinement guide 672 and the second alignment guide 674 take the form of a hole as discussed above a mark can be placed on the core of the pickleball paddle by passing the tip of a marking device (e.g., a pencil, a pen or an awl). Once the marks are in place, at least a portion of the releasable cover sheet over the adhesive material, as discussed herein, can then be removed from the face sheet 614 after which the marks on the core made using the first alinement guide 672 and the second alignment guide 674 along with, for example, another major feature of the face sheet 614 (e.g., the third major edge 654) can be used to precisely position the face sheet 614 on the core of the pickleball paddle.

In an alternative embodiment, the first alinement guide 672 and the second alignment guide 674 can be used in conjunction with an accessory device to assist in aligning the face sheet 614 on the core of the pickleball paddle. For example, such an accessory device could include a tool having two or more rods or extensions that are size and relatively positioned so as to pass through or into the first alinement guide 672 and the second alignment guide 674. In use, the tool could be used to help position and reposition the face sheet 614 the core so as to properly align the edges of the face sheet 614 with the core before adhering the face sheet 614 to the core. Once aligned, the tool can help to hold the face sheet 614 in position as the adhesive on the face sheet 614 is exposed (as discussed herein). The tool can then help maintain the alignment of the face sheet 614 is it is lowered down onto and secured to the core (e.g., core 102) of the pickleball paddle. In addition to passing through the first alinement guide 672 and the second alignment guide 674, the tool could also seat into openings present in the core (e.g., core 102) that are positioned and sized in conjunction with the face sheet 614 to ensure that the alignment of the face sheet 614 is precise so as to allow its proper placement as discussed herein.

For the various embodiments, the face sheet 214, 314, 414, 514, 614 can further include an adhesive material on at least a portion of the second major surface 220, 320, 420, 520, 620 of the backing 216, 316, 416, 516, 614. For the various embodiments, the adhesive material can help to secure the face sheet 214, 314, 414, 514, 614 to the pickleball paddle (e.g., to the core of the pickleball paddle). In certain embodiments, the adhesive material is not present between the first minor edge portion 236, 336, 436, 536, 636 and the second minor edge portion 252, 352, 452, 552, 652 of the backing 216, 316, 416, 516, 616. In other embodiments, the adhesive material is present between the first minor edge portion 236, 336, 436, 536, 636 and the second minor edge portion 252, 352, 452, 552, 652 of the backing 216, 316, 416, 516, 616. In certain additional embodiments, the adhesive material is not, or may not, be present on the first tab 360, 460, 560, 660 or the second tab 362, 462, 562, 662 as discussed herein. For the various embodiments, the adhesive material can be selected from the group consisting of contact cement, a thermoplastic based adhesive, a cyanoacrylate based adhesive, a polyurethane based adhesive, a pressure-sensitive adhesive, an acrylic-based adhesive, a rubber-based adhesive, a hot-melt adhesive and combinations thereof. Each of the aforementioned adhesives are known in the art. Specific examples of the adhesive material include acrylic adhesives, which are often derived from esters of acrylic and methacrylic acids, such as polymethyl methacrylate and polyacrylates formed with, among other monomers, 2-ethylhexyl acrylate and butyl acrylate.

For the various embodiments, the face sheet 214, 314, 414, 514, 614 can further include a releasable cover sheet over the adhesive material. For the various embodiments, the releasable cover sheet can protect the adhesive material present on the least a portion of the second major surface 220, 320, 420, 520, 620 from contaminates, prevents sticking to unintended surfaces and to better ensure the adhesive material remains clean and effective until it is ready to be used. Examples of a releasable cover sheet can include those materials having a low adhesion to the adhesive material, which can include, but are not limited to silicone-coated paper, film, or other non-stick materials that include a release agent or coating.

Referring now to FIG. 6B, there is shown an embodiment in which the releasable cover sheet 676 includes a first portion 678 and a second portion 680 over the adhesive material. For the various embodiments, either of the first portion 678 or the second portion 680 can be removed from the face sheet 614 without needing to or necessarily removing the other portion (e.g., the releasable cover sheet 676 includes a perforation between first portion 678 and a second portion 680). This allows for the first portion 678 to be removed prior to removing the second portion 680, which in turn allows for the first alinement guide 672 and the second alignment guide 674 along with the third major edge 654 to be used to position the face sheet 614 on the core of the pickleball paddle in an at least partially secured state. The face sheet 614 having the second portion 680 of the releasable cover sheet 676 still in place can then be brought into contact with the core to make sure the remaining major features of the face sheet properly align with the core. If the features are not in alignment the face sheet 614 can be removed and repositioned until the features align. After aligning the major features, the second portion 680 of the releasable cover sheet 676 can then be removed and the face sheet 614 secured to the core.

For the various embodiments, at least a portion of the first major surface 218, 318, 418, 518, 618 can include a patterned texture. For the various embodiments, the patterned texture on at least a portion of the first major surface 218, 318, 418, 518, 618 helps to provide grip against a surface of a pickleball being struck by the pickleball paddle having the face sheet 214, 314, 414, 514, 614. For the various embodiments, the pattern texture, if present, can conform to the approved Equipment Standards Manual of the USA pickleball and/or the International Federation of Pickleball, both of which are incorporated herein by reference.

For the various embodiments, the patterned texture includes, or can include, a grit material embedded in the backing 216, 316, 416, 516, 616. For example, the grit material can have a grit number in a range of 60 to 120. Examples of grit material include, but are not limited to, silicon carbide, aluminum oxide and combinations thereof. For the various embodiments, the patterned texture is, or can be, formed with a rubber based material, a silicon based material and combinations thereof. For the various embodiments, the patterned texture is, or can be, formed with a silicon based material. Players can select different levels of grit, textures, and materials to tailor the paddle's grip to their liking, enhancing performance and comfort. Examples of the patterned texture can also include diamond like, nano textured and/or micro textured surfaces and/or coatings. For the embodiments, the backing 216, 316, 416, 516, 616 can also include perforations to allow air to pass between the first major surface 218, 318, 418, 518, 618 and the second major surface 220, 320, 420, 520, 620 as the face sheet 214, 314, 414, 514, 614 is applied to the paddleball paddle.

For the various embodiments, the backing 216, 316, 416, 516, 616 can be formed of graphite, carbon fiber, fiberglass, aramid fiber, a thermoplastic film, wood pulp, a woven fabric, a felted fabric and combinations thereof. The material of the backing 216, 316, 416, 516, 616 can also be selected so as to be translucent so as to allow logos to show through the face sheet 214, 314, 414, 514, 614. For the various embodiments, the backing 216, 316, 416, 516, 616 can have a thickness between the first major surface 218, 318, 418, 518, 618 and the second major surface 220, 320, 420, 520, 620 of 1 to 10 millimeters (mm). Other thickness are possible and include 3 to 9 mm and 4 to 8 mm. Commercially available examples of materials suitable for forming the face sheet 214, 314, 414, 514, 614 include ARMORLam®5, which has a 1 mm (4 mil) thick textured non-vinyl backing with an adhesive material. Graphics can also be printed on this material.

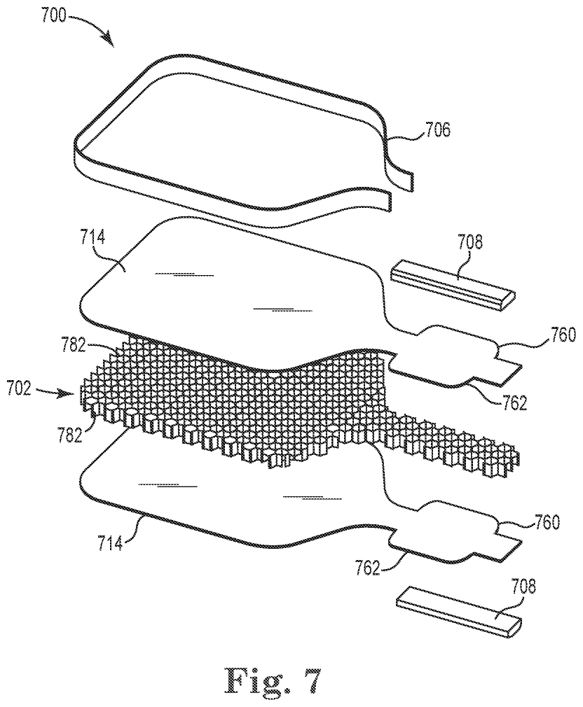

Referring now to FIG. 7, there is shown an embodiment of the present disclosure that includes a pickleball paddle 700 that includes: a core structure 702, as discussed herein, having handle 708 and a hitting surface 780; and a face sheet 714 of any one of the embodiments provided herein, where the face sheet 714 is releasably positioned over the hitting surface 780 of the pickleball paddle 700. A significant advantage of the face sheet of the present disclosure is that the need for frequent pickleball paddle replacements or extensive resurfacing procedures is not needed thereby saving both time and money.

1. A face sheet for resurfacing a pickleball paddle, the face sheet comprising:
a backing having a first major surface and a second major surface opposite the first major surface, wherein the first major surface and the second major surface include:
a first major edge having a first major linear portion extending between a first end and a second end, a first convex corner extending from the first end, a second convex corner extending from the second end, a first concave corner extending from the second convex corner and a first minor edge portion extending from the second convex corner away from both the first end and the second end of the first major linear portion;
a second major edge having a second major linear portion extending between a third end and a fourth end, a third convex corner extending from the third end, a fourth convex corner extending from the fourth end, a second concave corner extending from the fourth convex corner and a second minor edge portion extending from the fourth convex corner away from both the third end and the fourth end of the second major linear portion;
a third major edge having a third major linear portion extending between the first convex corner of the first major edge and the third convex corner of the second major edge;
a first minor edge extending between the first minor edge portion and the second minor edge portion;
a first tab extending from the first minor edge portion of the first major edge; and
a second tab extending from the second minor edge portion of the second major edge; and
a patterned texture on at least a portion of the first major surface to provide grip against a surface of a pickleball being struck by the pickleball paddle having the face sheet.

2. The face sheet of claim 1, further including an adhesive material on at least a portion of the first tab and the second tab.

3. The face sheet of claim 1, wherein the first tab and the second tab are covered with the adhesive material.

4. The face sheet of claim 1, wherein the first tab includes a first surface defining hook structures and the second tab includes a second surface defining loop structures that releasably engage with the hook structures of the first surface.

5. The face sheet of claim 1, wherein the backing further includes a reinforcement strip that extends from the third major edge and the first minor edge.

6. The face sheet of claim 5, wherein the reinforcement strip extends adjacent to the first major edge, the second major edge and the third major edge to a position between the first tab and the second tab.

7. A face sheet for resurfacing a pickleball paddle, the face sheet comprising:
a backing having a first major surface and a second major surface opposite the first major surface, wherein the first major surface and the second major surface include:
a first major edge having a first major linear portion extending between a first end and a second end, a first convex corner extending from the first end, a second convex corner extending from the second end, a first concave corner extending from the second convex corner and a first minor edge portion extending from the second convex corner away from both the first end and the second end of the first major linear portion;
a second major edge having a second major linear portion extending between a third end and a fourth end, a third convex corner extending from the third end, a fourth convex corner extending from the fourth end, a second concave corner extending from the fourth convex corner and a second minor edge portion extending from the fourth convex corner away from both the third end and the fourth end of the second major linear portion;
a third major edge having a third major linear portion extending between the first convex corner of the first major edge and the third convex corner of the second major edge;
a first minor edge extending between the first minor edge portion and the second minor edge portion; and
a reinforcement strip that extends from the third major edge and the first minor edge; and
a patterned texture on at least a portion of the first major surface to provide grip against a surface of a pickleball being struck by the pickleball paddle having the face sheet.

8. The face sheet of claim 7, wherein the reinforcement strip extends adjacent to the first major edge, the second major edge and the third major edge to a position between the first tab and the second tab.

9. The face sheet of claim 7, wherein the backing includes:
a first tab extending from the first minor edge portion of the first major edge; and
a second tab extending from the second minor edge portion of the second major edge.

10. The face sheet of any one of claim 9, further including an adhesive material on at least a portion of the first tab and the second tab.

11. The face sheet of claim 9, wherein the first tab and the second tab are covered with the adhesive material.

12. The face sheet of claim 9, wherein the first tab includes a first surface defining hook structures and the second tab includes a second surface defining loop structures that releasably engage with the hook structures of the first surface.

13. The face sheet of claim 7, further including an adhesive material on at least a portion of the second major surface of the backing, wherein the adhesive material helps to secure the face sheet to the pickleball paddle.

14. The face sheet of claim 13, wherein the adhesive material is not present between the first minor edge portion and the second minor edge portion of the backing.

15. The face sheet of claim 13, wherein the adhesive material is selected from the group consisting of contact cement, a thermoplastic based adhesive, a cyanoacrylate based adhesive, a polyurethane based adhesive, a pressure-sensitive adhesive, an acrylic-based adhesive, a rubber-based adhesive, a hot-melt adhesive and combinations thereof.

16. The face sheet of claim 7, wherein the backing is formed of graphite, carbon fiber, fiberglass, aramid fiber, a thermoplastic film, wood pulp, a woven fabric, a felted fabric and combinations thereof.

17. The face sheet of claim 7, wherein the patterned texture is formed with a grit material embedded in the backing, a rubber based material, a silicon based material and combinations thereof.

18. The face sheet of claim 7, wherein the backing includes perforations to allow air to pass between the first major surface and the second major surface as the face sheet is applied to the paddleball paddle.

19. The face sheet of claim 7, wherein the backing includes a first alignment guide and the second alignment guide, wherein the first alignment guide and the second alignment guide are physically separated from each other and are located between the first major edge, the second major edge and the third major edge, wherein the first alignment guide and the second alignment guide assist with positioning the face sheet on the pickleball paddle.

20. A pickleball paddle, comprising:
a core structure having handle and a hitting surface; and
a face sheet of claim 7 releasably positioned over the hitting surface of the pickleball paddle.
